(19) United States
(12) Patent Application Publication
(10) Pub. No.: US 2015/0250197 A1
(43) Pub. Date: Sep. 10, 2015

(54) DAIRY-BASED SNACK PRODUCTS AND METHOD OF MANUFACTURE OF SAME

(71) Applicant: Sergey Konchakovskiy, Staten Island, NY (US)

(72) Inventor: Sergey Konchakovskiy, Staten Island, NY (US)

(21) Appl. No.: 14/198,893

(22) Filed: Mar. 6, 2014

(51) Int. Cl. A23C 23/00; A23L 1/00

(52) U.S. Cl. CPC A23C 23/00; A23L 1/0067

(57) ABSTRACT

A portable dairy-based snack food product is provided with similar shape, appearance and convenience as a conventional candy bar where inner core is replaced with healthier more nutritional dairy based filling mixture. The dairy based filling mixture is composed of a yogurt based product and a dairy based product. The mixture is enrobed by an edible shell. The yogurt based product may be of any type, including Greek yogurt. The dairy based product is selected from the group consisting of soft cheese, cheese curd, farmers cheese, cottage cheese, ricotta cheese, cream cheese, neufchâtel cheese and mixtures thereof.

### BACKGROUND

I. Field of the Invention

The present invention relates to the field of food compositions and method of manufacture of same. More specifically, this invention relates to dairy-based snack products that are portable and comprise a mixture of yogurt and other dairy-based products enveloped in a chocolate or other type of glaze compound.

II. Background of the Related Art

Demand for snack food by consumers has increased significantly over the past decade. Snacking has become a long-term trend that is replacing formal meals in many households all over the world. Because of the consumer demand for snacks, food companies are offering more and more varieties of snack food products. These snack foods are generally priced at a lower point than other grocery items, and are often purchased to satisfy an immediate urge.

With obesity and related health concerns, such as heart disease, hypertension, diabetes, etc., on the rise, consumers are looking to products that help reduce or control daily caloric intake as well as control body weight and body appearance. Snack food which can be consumed as a single-serving food product, such as a bar or a drink, can replace one or two meals per day and thus provides an ideal dietary solution for consumers who seek a restricted caloric intake and a healthy balance of nutritional ingredients.

Many snack foods, however, fail to offer the right balance of nutrition and taste that appeal to consumers. The snacks that people crave are typically high in fat, sugar and cholesterol. Those snacks that provide nutritional benefits are not as popular since they often are not as tasty.

Aiming to strike that perfect balance of healthy nutrition and good taste, food companies have turned to dairy-based products. It is generally known that consuming at least three servings of milk, cheese or yogurt every day helps people meet their daily calcium, potassium, proteins and other nutrient needs. By developing snacks that contain dairy, food manufacturers can fulfill consumers' need for snacks that are natural and authentic, and provide real nutrient benefits.

To further reduce calorie intake, it can be beneficial to introduce yogurt, and more specifically, Greek yogurt as a key ingredient. Yogurts are creamy or liquid acidified dairy products that are manufactured from milk or a milk component by using thermophilic lactic acid bacteria. In the United States, 21 C.F.R. 131.200 sets forth the composition, allowed and required ingredients, and labeling requirements for traditional yogurts.

Greek yogurts, also known as strained yogurt, yogurt cheese or labneh, have become especially popular. The “greek” type of yogurt is produced by straining a conventional yogurt using either a cloth or paper bag to filter and remove whey, giving a consistency between that of yogurt and cheese, while preserving yogurt's distinct slightly sour taste. Since Greek yogurt is essentially made from a highly concentrated form of milk, it provides more calcium intake than an equivalent glass of fresh milk. The composition of Greek yogurt contains an average of about 20 percent calcium, making it an effective bone strengthener. Greek yogurt is also among the high-satiety index foods. Many dietitians agree that foods with high-satiety indices, such as tuna, bring more gustatory satisfaction than foods with lower satiety indices. This means that 6 ounces of Greek yogurt will make a person feel fuller than, for instance, 6 ounces of soup.

Greek yogurt also typically consists of 30 percent protein, which makes it a rich source of muscle-building material. Combined with its low-fat properties, this makes it a tasty, guilt-free treat. Further to its nutritional benefits, Greek yogurt makes a great snacking food due to its flexibility to be combined with tasty and healthy ingredients and toppings. Greek yogurt, just like any other yogurt, can be mixed with fruits and berries for a delicious dessert. Breakfasts also become richer and crunchier when granola and almonds are combined with Greek yogurt.

While Greek yogurt is of higher viscosity than a traditional yogurt, its texture is still unsuitable for small size portable snack food. Hence, it is offered in a cup to be eaten with a spoon. For more portable offerings to be consumed without utensils, one prior art solution is to provide the yogurt product in a tube. Another solution is to mix the yogurt with hydrocolloid gum ingredients to achieve a gelled-type dairy mixture. This introduces an unnatural and in some instances unhealthy ingredient to the final product.

Yet another solution is to freeze the yogurt and separate it by forming individual portions. This type of solution offers a “chilled” final product requiring specific storage requirements and introducing unnecessary complications to the manufacturing process.

In view of the above, a need exists for a healthy small sized dairy-based snack food product, having balanced nutrition while providing maximum health benefits. There further exists a need for a dairy-based snack product that is portable and can be consumed without utensils. In addition, a process of manufacture that is capable of delivering such snack products whose nutritional profile is uncompromised by the addition of undesirable components is also needed. It is also desired that such snack products not have specific storage requirements or involve complicated manufacturing processes.

### SUMMARY

In an embodiment of the present invention, a portable dairy-based snack product is provided. The dairy based product comprises an outer edible shell, a dairy-based filling mixture enveloped by the outer shell, wherein the dairy-based filling mixture comprises a mix of yogurt and dairy-based product in a predetermined ratio. The outer edible shell content preferably ranges from about 10-30% and the dairy based filling mixture content ranges from 70-90%. Furthermore, the outer edible shell may be a composition of chocolate based product. The dairy based filling mixture may a composition of yogurt product with solids content from 10-40% and dairy product with solids content from 10%-40% by weight. The dairy product may be selected from the group consisting of soft cheese, cheese curd, farmers cheese, cottage cheese, ricotta cheese, cream cheese, neufchâtel cheese and mixtures thereof. In addition, the dairy based filling mixture may further comprise a non-dairy filling selected from the group consisting of fruit jam, fresh fruits, fruit puree, condensed milk, coffee, chocolate and mixtures thereof.

In another embodiment of the present invention an improved method of manufacturing a dairy based snack product is provided. The method comprises the steps of preparing a dairy based filling mixture, mixing the dairy based filling mixture, cooling the dairy based filling mixture until the temperature reaches 32-40 F, forming and cutting the cooled dairy based filling mixture into a predetermined shape, enveloping the formed dairy based filling mixture with an edible glazing compound and cooling the glazed and formed dairy based filling mixture until the temperature reaches 32-40 F. The method may further comprise the step of injecting (or bending with) a non-dairy filling into the formed dairy based filling mixture, the non-dairy filling selected from the group consisting of fruit jam, fresh fruits, fruit puree, condensed milk, coffee, chocolate and mixtures thereof. The dairy based filling mixture is composed of a yogurt based product and a dairy based product, the dairy based product selected from the group consisting of soft cheese, cheese curd, farmers cheese, cottage cheese, ricotta cheese, cream cheese, neufchâtel cheese and mixtures thereof.

Other features and advantages of the embodiments of the present invention will become apparent from the following more detailed description, taken in conjunction with the accompanying drawings, which illustrate, by way of example, the principles of at least one of the possible embodiments of the invention.

### BRIEF DESCRIPTION OF THE DRAWINGS

The accompanying drawings illustrate at least one of the best mode embodiments of the present invention. In such drawings:

FIG. 1 illustrates examples of various shapes of the dairy-based snack product of the present invention.

The above-described drawing figures illustrate the present invention in at least one of its preferred, best mode embodiments, which are further defined in detail in the following description. Those having ordinary skill in the art may be able to make alterations and modifications in the present invention without departing from its spirit and scope. Therefore it must be understood that the illustrated embodiments have been set forth only for the purposes of example and that they should not be taken as limiting the invention as defined in the following.

### DETAILED DESCRIPTION

The following detailed description is exemplary in nature and is not intended to limit the scope, applicability, composition or configuration of the invention in any way. Rather, the following description provides practical illustrations for implementing exemplary embodiments of the present invention.

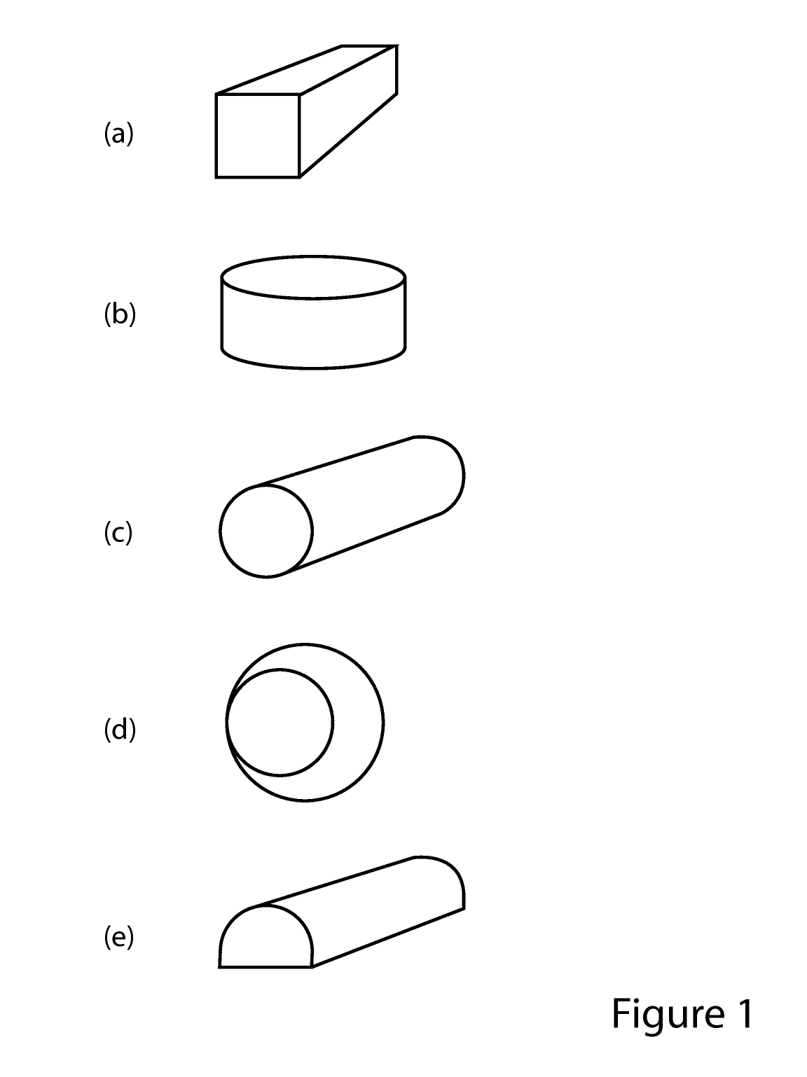

In accordance with a preferred embodiment disclosed herein, a novel dairy-based snack food product is provided having similar shape, appearance and convenience as, for example, a conventional candy bar wherein its inner core composition is replaced with healthier more nutritional dairy mix comprising primarily high-solid yogurt, including e.g., Greek type yogurt, with an optional addition of fermented soft cheeses such as cheese curd, farmers cheese, cottage cheese, ricotta cheese, cream cheese, neufchâtel cheese, etc. Examples of the variety of types and shapes that can be prepared with food compositions according to some embodiments include, but not limited to, rectangular, round (e.g., puck shaped), spherical (e.g., ball) or cylindrical structure, as illustrated in FIG. 1.

In accordance with another embodiment of the present invention a method of manufacture of the dairy-based snack product is provided. The method delivers a product of various shapes that is portable, visually appealing, satiating, and whose nutritional profile is uncompromised by the addition of high calorie, fat and cholesterol additives. In accordance with one embodiment, the dairy-based snack product is prepared by replacing the core (center) of the conventional candy bar, typically enveloped by chocolate glaze or another type of glaze compound, with the dairy mixture comprising 1) dehydrated yogurt, 2) dehydrated soft cheese, cheese curd or cheese quark or 3) a proprietary combination of both 1) and 2) with the optional addition of other ingredients.

### Composition

In accordance with one embodiment, the dairy based mixture within the snack product comprises high-solids yogurt of any type, including Greek yogurt and conventional (liquid) yogurt. Alternatively, the dairy-based mixture comprises a blend of yogurt and soft cheese in a predetermined ratio ranging from 1:1 to 5:1 by weight. In accordance with another embodiment of the present invention, the dairy-based mixture is a blend of yogurt, soft cheese and various types of added sweeteners.

In accordance with one embodiment, the soft cheese content of the dairy based mixture can range from 0 to 99% by weight. The dairy-based mixture may also incorporate, either by blending or injecting, additional filling ingredients, such as fresh fruits, frozen fruits, fruit jams, fruit puree, chocolate, coffee, condensed milk or any other type of food filling. The dairy-based mixture, with or without additional fillings, can be enrobed in chocolate, chocolate compound or other food glazing material. Supplemental ingredients such as natural or artificial flavors, colors, preservatives, fats and oils, vitamins, probiotic bacteria, antioxidants, emulsifiers, glazing agents, stabilizers, as well as other ingredients common to snack foods and familiar to persons of ordinary skill in the art, may be added into the dairy-based mixture, as desired.

The food composition of the dairy-based snack product according to one embodiment comprises the following main ingredients:

1) Unsweetened dairy food snack: Glaze: 10-25%, Dairy-based mixture including filling: 75-90%;

2) Sweetened dairy food snack: Glaze: 10-25%, Dairy-based mixture including filling: 50-80%, Sugar: 10-25%.

The dairy based mixture preferably comprises a composition of yogurt based product and the dairy based product in a ratios ranging from 1:1 to 5:1. (See examples 1-5 below)

Forms and Weight.

As illustrated FIG. 1 (a)-(e), the dairy-based food snack product may be manufactured in a variety of shapes, including, without limitation, rectangular, round (e.g., hockey puck), spherical or cylindrical. The shapes disclosed herein are examples, and are not intended to limit the scope of the claims to these shapes to the exclusion of others. The snack product may be produced having various weights, ranging from 10 and 250 grams for single serving.

### Product Variations

In accordance with additional embodiments, the dairy-based snack product takes the form of a dairy-based mixture filling enrobed in chocolate. The variety of ingredients for the dairy-based mixture filling within the snack may vary, and some examples of mixture ingredients include yogurt, vanilla, various forms of cheese, fruit, and/or jam. Additional example compositions, according to different embodiments, include:

### 1) Chocolate Enrobed Sweetened Vanilla Flavored Yogurt Snack;

2) Chocolate Enrobed Sweetened Nonfat (Low fat) Vanilla Flavored Yogurt Snack;

### 3) Chocolate Enrobed Unsweetened Vanilla Flavored Yogurt Snack;

4) Chocolate Enrobed Unsweetened Nonfat (Low fat) Vanilla Flavored Yogurt Snack;
5) Chocolate Enrobed Sweetened Yogurt Snack with Fruit Filling;
6) Chocolate Enrobed Sweetened Nonfat (Low fat) Yogurt Snack with Fruit Filling;
7) Chocolate Enrobed Unsweetened Yogurt Snack with Fruit Filling;
8) Chocolate Enrobed Unsweetened Nonfat (Low fat) Yogurt Snack with Fruit Filling;

### 9) Chocolate Enrobed Sweetened Vanilla Flavored Yogurt & Cheese Snack;

10) Chocolate Enrobed Sweetened Nonfat (Low fat) Vanilla Flavored Yogurt & Cheese Snack;

### 11) Chocolate Enrobed Unsweetened Vanilla Flavored Yogurt & Cheese Snack;

12) Chocolate Enrobed Unsweetened Nonfat (Low fat) Vanilla Flavored Yogurt & Cheese Snack;
13) Chocolate Enrobed Sweetened Yogurt & Cheese Snack with Fruit Filling;
14) Chocolate Enrobed Sweetened Nonfat (Low fat) Yogurt & Cheese Snack with Fruit Filling;
15) Chocolate Enrobed Unsweetened Yogurt & Cheese Snack with Fruit Filling;
16) Chocolate Enrobed Unsweetened Nonfat (Low fat) Yogurt & Cheese Snack with Fruit Filling;

### 17) Chocolate Enrobed Sweetened Vanilla Flavored Cheese Snack;

18) Chocolate Enrobed Sweetened Nonfat (Low fat) Vanilla Flavored Cheese Snack;

### 19) Chocolate Enrobed Unsweetened Vanilla Flavored Cheese Snack;

20) Chocolate Enrobed Unsweetened Nonfat (Low fat) Vanilla Flavored Cheese Snack;
21) Chocolate Enrobed Sweetened Cheese Snack with Fruit Filling;
22) Chocolate Enrobed Sweetened Nonfat (Low fat) Cheese Snack with Fruit Filling;
23) Chocolate Enrobed Unsweetened Cheese Snack with Fruit Filling;
24) Chocolate Enrobed Unsweetened Nonfat (Low fat) Cheese Snack with Fruit Filling.
The chocolate enrobing may be replaced by white chocolate or another type of compound chocolate, which does not contain cocoa solids. The alternative coating compound does not contain cocoa butter or cocoa liquor, but rather selection of vegetable fats selected for their consistent crystallization.

### Composition Examples

Example ingredients and their relative amounts that composing the dairy-based snack product in accordance with certain embodiments include:

### Example 1

### Chocolate Enrobed Sweetened Vanilla Flavored Yogurt Snack

Chocolate Glaze—20%
Yogurt (8% fat, 25% solids) —58%
Refined White Sugar (moisture max 0.04%) —21.005%
Vanilla Natural Flavor—0.005%

### Example 2

### Chocolate Enrobed Sweetened Nonfat (Low Fat) Vanilla Flavored Yogurt & Cheese Snack

Chocolate Glaze—20%
Yogurt (0% fat, 20% solids)—38%
Farmers Cheese (0% fat, 20% solids)—20%
Refined White Sugar (moisture max 0.04%)—20.005%
Vanilla Natural Flavor—0.005%
Pectin—1%

### Example 3

Chocolate Glaze—20%
Yogurt (0% fat, 25% solids)—48%
Cream Cheese (10% fat, 45% solids)—10%
Sugar—20.005%
Vanilla—0.005%
no Pectin

### Example 4

### Chocolate Enrobed Sweetened Yogurt Snack with Fruit Filling

Chocolate Glaze—20%
Yogurt (8% fat, 25% solids)—50%
Refined White Sugar (moisture max 0.04%)—15%
Fruit Filling (solids 70%)—15%

### Example 5

### Chocolate Enrobed Unsweetened Yogurt & Cheese Snack with Fruit Filling

Chocolate Glaze—20%
Yogurt (8% fat, 25% solids)—60%
Well-drained Fresh Fruit Puree (solids 80%)—19.5%
Pectin—0.5%

Food compositions according to some embodiments may further contain various additives that are added to the dairy mix to be used for taste and quality enhancement. The quantities of these ingredients can be substantially negligible compared to the overall composition of the snack product, and will not substantially alter the foregoing disclosed example compositions. Examples include, but not limited to natural flavors, natural colors, natural sweeteners (such as crystalline fructose, xylitol, sorbitol), acidifiers (such as citric acid), naturally derived hydrocolloids (gelling agents, thickening agents and stabilizers)—pectin, agar, carrageenan, gelatine, gum arabic, starch, and other ingredients familiar to persons of skill in the art. Functional ingredients, such as probiotics, vitamins, proteins and food fibers may be used as well, as desired.

Method of Manufacture

The method of manufacture of the dairy-based snack product in accordance with the preferred embodiment generally comprises the steps of preparing the dairy mix, cooling the dairy mix, processing the mix through molding/forming/cutting machine, processing through glazing machine, cooling the bars, and packaging.

The step of preparation of the dairy mix is carried out in accordance with the recipe of the particular variety of the dairy based mixture contained with a mixing machine, or any other means, machines or methods of mixing food ingredients familiar to persons of skill in the art, and therefore, references to a mixing machine are not intended to limit the scope of the claims to any particular type of machine. For example, the mixture may contain a predetermined amount of ready-to-use yogurt or soft cheese or a blend of both with fat content 0-25% and total solids content 10-45%. Ready-to-use yogurt comes from a manufacturer in bulk with its own specifications. If necessary, this dairy blend may be mixed with refined sugar with moisture of no more than 0.04% and a choice of (a) vanilla flavor (if vanilla variety), (b) pectin or other thickening agent (if the dairy based mixture is of non-fat/low-fat variety with low solids), (c) a fruit filling or a fresh fruit puree with 50-80% solids, which may be blended within the dairy based mixture or simply injected unblended within the core center, depending on the fruit filling variety.

Mixing step: The ready-to-use ingredients mentioned above or a blend thereof are chilled to 2 C-4 C and mixed together for 3 to 6 minutes.

Cooling Step: Once mixed, the dairy-based mixture is unloaded from the mixing machine, packed in food grade bins, optionally marked by separate lot number and transferred to a refrigerator, or other cool machine or mechanism known to persons of skill in the art where it is cooled until the temperature reaches 32-40 F or 1-3 C.

Forming Step. Once cooled to the appropriate temperature, the dairy-based mixture is fed to the hopper of the molding/forming/cutting machine which forms and cuts bars. The forming machine's cycle may start automatically. At this point the optional filling, if not blended with the dairy based mixture previously, can be injected inside of the bar or applied on top of it. The fruit filling, jam or puree contains total solids ranging from 50-80%.

Enrobing/Glazing Step. The glazing process starts when the dairy based mixture bars are properly formed and conveyed to the glazing machine. Once the chocolate or an alternative glazing compound reaches a temperature of 35-35 C (95-105 F) the snack bars may be coated to completely enrobe the pre-formed dairy based mixture. The excess frosting glaze is removed from the bars with pressured warm air. The coating compound may be pre-manufactured, ready-to-use chocolate or other oil-based glaze.

Cooling and Hardening Step. The glazed snack bars are conveyed to the air cooling chamber of the cooling machine where they are cooled until a temperature of 32-40 F (1-3 C) is reached. The temperature in the chamber (tunnel) is preferably 18-20 C. The snack moves inside a 6 meter cooling tunnel at approximately 0.5-1.5 meters/minute so that the temperature of the snack at the exit of the tunnel is between 1-3 C. Air movement speed is approximately 1-1.5 meters/sec. Chocolate or any other glaze compound hardens completely at this temperature.

Packaging step. The packaging step preferably utilizes the industrial machine “flow-pack” technology, where the coated food snacks are wrapped. The present invention is not limited to any specific type of packing technology and any packing technique can be used.

Storing step. The completely packed food snacks are stored at temperature of 33-36 F (1-6 C). The dairy based snack product of the present invention does not need to be frozen.

Apparatus of Manufacture

In accordance with a preferred embodiment, an apparatus for the mass production of dairy based snack product of various shapes comprises:

(1) An industrial mixer (with preferred capacity over 100 liters).

(2) A forming and cutting machine which uses an extrusion method, pushing the dairy mix through a die and forming transverse shape of the snack. The machine is also capable of cutting a continuous snack flow for pieces of a desired length, using a steel string, and conveying the pre-cut pieces to the next step.

(3) A filling injecting machine may be optionally used for injecting a filling into the middle of pre-formed snack. The machine pumps the filling (fruit jam, soft chocolate, etc.) through small pipes inserted into the middle of a forming die.

(4) A glaze enrobing machine is used to enrobe formed snacks in chocolate or other oil-based compound and blowing off excess compound with forced air. The enrobed snack is then conveyed to the next step.

(5) A cooling machine conveys glazed snacks through a cooling tunnel where snacks are cooled off by cold air flow. Snack temperature may decrease to 1° C.-3° C. at the tunnel exit where the glazed and cooled snack is conveyed to the next step.

(6) A wrapping machine may be of “flow-pack” type, which automatically wraps up the glazed dairy-based snack products into bi-axially orientated laminated polypropylene film and puts on the date of manufacture. Following the wrapping step, the packaged snack product may be removed using a removing transporter.

Various modifications and variations of the described dairy-based snack products, their compositions and methods of manufacture will be apparent to those skilled in the art without departing from the scope and spirit of the invention. Although the disclosure has been described in connection with specific preferred embodiments, it should be understood that the invention as claimed should not be unduly limited to such specific embodiments. Indeed, those skilled in the art will recognize, or be able to ascertain using no more than routine experimentation, many equivalents to the specific embodiments of the invention described herein. Such equivalents are intended to be encompassed by the following claims.

What is claimed is:

1. A portable snack food product, comprising:
an outer edible shell;
a dairy-based filling mixture enveloped by the outer shell;
wherein the dairy-based filling mixture comprises a mix of yogurt and dairy-based product in a predetermined ratio.

2. The product of claim 1, wherein the predetermined ratio ranges from about 1:1 to 5:1.

3. The product of claim 1, wherein the outer edible shell content ranges from about 10-30% and the dairy based filling mixture content ranges from 70-90%.

4. The product of claim 1, wherein the outer edible shell is a composition of chocolate based product.

5. The product of claim 1, wherein the dairy based filling mixture is a composition of yogurt product with solids content from 10-40% and dairy product with solids content from 10%-40% by weight.

6. The product of claim 1, wherein the dairy product is selected from the group consisting of soft cheese, cheese curd, farmers cheese, cottage cheese, ricotta cheese, cream cheese, neufchâtel cheese and mixtures thereof.

7. The product of claim 1, wherein the dairy based filling mixture further comprises a non-dairy filling selected from the group consisting of fruit jam, fresh fruits, fruit puree, condensed milk, coffee, chocolate and mixtures thereof.

8. A method of manufacture of a portable snack food product, comprising the steps of:
preparing a dairy based filling mixture;
mixing the dairy based filling mixture;
cooling the dairy based filling mixture until the temperature reaches 32-40 F;
forming and cutting the cooled dairy based filling mixture into a predetermined shape;
enveloping the formed dairy based filling mixture with an edible glazing compound;
cooling the glazed and formed dairy based filling mixture until the temperature reaches 32-40 F.

9. The method of claim 8, further comprising the step of injecting a non-dairy filling into the formed dairy based filling mixture, the non-dairy filling selected from the group consisting of fruit jam, fresh fruits, fruit puree, condensed milk, coffee, chocolate and mixtures thereof.

10. The method of claim 8, further comprising the step of blending a non-dairy filling with the mixed dairy based filling mixture, the non-dairy filling selected from the group consisting of fruit jam, fresh fruits, fruit puree, condensed milk, coffee, chocolate and mixtures thereof.

11. The method of claim 8, wherein the dairy based filling mixture is composed of a yogurt based product and a dairy based product, the dairy based product selected from the group consisting of soft cheese, cheese curd, farmers cheese, cottage cheese, ricotta cheese, cream cheese, neufchâtel cheese and mixtures thereof.

12. A portable dairy based snack food product, comprising:
an outer edible shell composed of chocolate or oil-based glazing compound;
a dairy based filling mixture completely enveloped by the outer shell;
wherein the dairy based filling mixture comprises a mix of yogurt and dairy based product in a predetermined ratio; the outer edible shell content ranging from 15-25%; yogurt content ranging from 35-65%; dairy product content ranging from 0-35%.

13. The portable dairy based snack food product of claim 12, wherein the dairy based filling mixture further comprises a non-dairy filling selected from the group consisting of fruit jam, fresh fruits, fruit puree, condensed milk, coffee, chocolate and mixtures thereof, the non-dairy filling content ranging from 0-25%.

14. The product of claim 12, wherein the dairy based product is selected from the group consisting of soft cheese, cheese curd, farmers cheese, cottage cheese, ricotta cheese, cream cheese, neufchâtel cheese and mixtures thereof.
